(19) United States
(12) Patent Application Publication
(10) Pub. No.: US 2018/0162198 A1
(43) Pub. Date: Jun. 14, 2018

(54) AIR CONDITIONING SYSTEM FOR VEHICLE AND VEHICLE HAVING SAME

(71) Applicant: BYD COMPANY LIMITED, Shenzhen, Guangdong (CN)

(72) Inventors: Huanhuan NIE, Shenzhen (CN); Xuefeng CHEN, Shenzhen (CN); Meijiao YE, Shenzhen (CN); Tingshuai TAN, Shenzhen (CN)

(73) Assignee: BYD COMPANY LIMITED, Shenzhen, Guangdong (CN)

(21) Appl. No.: 15/580,163

(22) PCT Filed: Jun. 7, 2016
(86) PCT No.: PCT/CN2016/085166

§ 371 Date: Dec. 6, 2017

(30) Foreign Application Priority Data
Jun. 15, 2015 (CN) 201510330136.3

(51) Int. Cl. B60H 1/00

(52) U.S. Cl. CPC B60H 1/00921; B60H 2001/00949; B60H 2001/00928

(57) ABSTRACT

Disclosed are an air conditioning system (100) for a vehicle and a vehicle having same. An air conditioning system (100) includes: a compressor (1), having a compressor inlet (11) and a compressor outlet (12); a first plate heat exchanger (2), having a pair of first inlet (21) and first outlet (22), and a pair of second inlet (23) and second outlet (24); a heat radiator (3), connected between the second inlet and the second outlet; an external air heat exchanger (72), disposed downstream of the first plate heat exchanger; a second plate heat exchanger (71), including a pair of third inlet (711) and third outlet (712), and a pair of fourth inlet (713) and fourth outlet (714); a motor radiator (74), connected between the fourth inlet and the fourth outlet; a first throttle control assembly (5), disposed between the first outlet and an inlet of the external air heat exchanger; and an internal refrigeration assembly, disposed between the compressor inlet and the third outlet.

### CROSS-REFERENCE TO RELATED APPLICATION

The present application claims priority to and benefits of Chinese Patent Application No. 201510330136.3, filed with the State Intellectual Property Office (SIPO) of the People's Republic of China on Jun. 15, 2015, the entire content of which is hereby incorporated by reference.

### FIELD

The present disclosure relates to an automobile manufacturing field, and more particularly relates to an air conditioning system for a vehicle and a vehicle including the same.

### BACKGROUND

In the related art, for an air conditioning system of an electric vehicle or a hybrid vehicle, it is general practice to use a heat pump air conditioning system or an air conditioning refrigeration system in combination with a positive temperature coefficient (PTC) thermistor to achieve refrigeration and heating functions of the air conditioning system of the vehicle.

For the heat pump air conditioning system, a component such as a four-way reversing valve is required. The four-way reversing valve shows an unstable performance during its application in the vehicle, and some problems may arise when the four-way reversing valve is at work, such as a direction switching delay or an unfulfilled direction switching, which may further cause an internal leakage and cross flow of the refrigerant in the air conditioning system. Once the four-way reversing valve is failed, it's impossible to achieve the refrigeration and heating functions of the heat pump air conditioning system of the vehicle.

For the refrigeration air conditioning system in combination with PTC, it should be noted that, PTC consumes electric power of the vehicle. To fulfill the requirements of heating, defrosting and demisting of the vehicle, PTC needs the large power, and thus consumes a large part of the electric power of the vehicle. Therefore, while using PTC to heat, the vehicle may waste much electric quantity thereof, which may seriously affect the endurance mileage of the electric vehicle.

### SUMMARY

The present disclosure aims to solve at least one of the above problems to some extent.

Accordingly, an air conditioning system for a vehicle is provided by the present disclosure. The air conditioning system for the vehicle solves some problems existing in the prior art and caused by the direction switching of the refrigerant, such as a cooling or heating delay, and a poor comfort, and also, the air conditioning system for the vehicle shows a low power consumption.

According to a first aspect of embodiments of the present disclosure, an air conditioning system for a vehicle is provided. The air conditioning system includes: a compressor, including a compressor inlet and a compressor outlet; a first plate heat exchanger, including a pair of first inlet and first outlet communicated with each other, and a pair of second inlet and second outlet communicated with each other, the compressor outlet being connected to the first inlet; a heat radiator, connected between the second inlet and the second outlet of the first plate heat exchanger, disposed inside the vehicle and configured to exchange heat with air inside of the vehicle, a first driving device being provided between the heat radiator and the first plate heat exchanger and configured to drive a first secondary refrigerant; an external air heat exchanger, disposed downstream of the first plate heat exchanger; a second plate heat exchanger, including a pair of third inlet and third outlet communicated with each other, and a pair of fourth inlet and fourth outlet communicated with each other, the third inlet being connected to an outlet of the external air heat exchanger; a motor radiator, configured to radiate heat of a motor of the vehicle, connected between the fourth inlet and the fourth outlet of the second plate heat exchanger, a second driving device being provided between the motor radiator and the second plate heat exchanger and configured to drive a second secondary refrigerant; a first throttle control assembly, disposed between the first outlet of the first plate heat exchanger and an inlet of the external air heat exchanger, configured to switch on/off a throttling function for a refrigerant flowing from the first plate heat exchanger to the external air heat exchanger; and an internal refrigeration assembly, configured to selectively cool the air inside the vehicle, and disposed between the compressor inlet and the third outlet of the second plate heat exchanger.

The air conditioning system for the vehicle according to embodiments of the present disclosure, compared with the heat pump air conditioning system provided with a four-way reversing valve in the prior art, may avoid some problems such as an internal leakage and a cross flow of the refrigerant caused by the failure of the four-way reversing valve, further enable a stable operation thereof, and solve some problems existing in a current air conditioning system such as a cooling or heating delay, a poor comfort and so on. Moreover, the air conditioning system for the vehicle, distinguished from the air conditioning system using the PTC for heating in the prior art, shows a low power consumption, which can increase an endurance mileage of an electric vehicle and a hybrid vehicle, and thus is very suitable for the electric vehicle and the hybrid vehicle.

According to a second aspect of embodiments of the present disclosure, a controlling method of the air conditioning system for the vehicle is provided. The air conditioning system for the vehicle has four operation modes, including a cooling mode, a heating mode, a cooling-heating compatible mode and a heating-defrosting mode. The controlling method includes:

when starting the cooling mode, switching off the first driving device, the first throttle device, the second driving device and the second on-off valve, and switching on the first on-off valve and the second throttle device;

when starting the heating mode, switching on the first driving device, the first throttle device, the second driving device and the second on-off valve, and switching off the first on-off valve and the second throttle device;

when starting the cooling-heating compatible mode, switching on the first driving device, the first on-off valve and the second throttle device, and switching off the first throttle device, the second driving device and the second on-off valve; and

when starting the heating-defrosting mode, switching on the first driving device, the first on-off valve and the second on-off valve, and switching off the first throttle device, the second driving device and the second throttle device.

In summary, with the controlling method according to embodiments of the present disclosure, the air conditioning system of the vehicle can achieve a cooling function, a heating function, a simultaneous cooling-heating function and a heating-defrosting function, without changing a circulation direction of the refrigerant. And also, the air conditioning system has a simple structure, a high comfort and low energy consumption.

According to a third aspect of embodiments of the present disclosure, a vehicle is provided. The vehicle includes the air conditioning system according to embodiments of the present disclosure. With the air conditioning system according to embodiments of the present disclosure having above advantages, the vehicle including the air conditioning system may be more energy efficient, and show better performances and driving comfort.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the accompanying drawings, in which:

FIG. 1 is a schematic view showing a principle of an air conditioning system for a vehicle according to an embodiment of the present disclosure; and

FIG. 2 is a schematic view of an internal refrigeration assembly of an air conditioning system for a vehicle according to an embodiment of the present disclosure.

### REFERENCE NUMERALS

air conditioning system 100 for vehicle;

compressor 1, compressor inlet 11, compressor outlet 12;

first plate heat exchanger 2, first inlet 21, first outlet 22, second inlet 23, second outlet 24;

heat radiator 3;

first driving device 4;

first throttle device 5, first throttle inlet 51, first throttle outlet 52;

first on-off valve 6, inlet 61 of first on-off valve 6, outlet 62 of first on-off valve 6;

second plate heat exchanger 71, third inlet 711, third outlet 712, fourth inlet 713, fourth outlet 714;

external air heat exchanger 72;

second driving device 73;

motor radiator 74;

second throttle device 8, second throttle inlet 81, second throttle outlet 82;

internal heat exchanger 9, inlet 91 of internal heat exchanger 9, outlet 92 of internal heat exchanger 9;

third plate heat exchanger 93, fifth inlet 931, fifth outlet 932, sixth inlet 933, sixth outlet 934;

air heat exchanger 94, third water pump 95, heat exchanging device 96, flow control device 97;

second on-off valve 10, inlet 101 of second on-off valve 10, outlet 102 of second on-off valve 10;

gas-liquid separator 20.

### DETAILED DESCRIPTION

Reference will be made in detail to embodiments of the present disclosure, where the same or similar elements and the elements having the same or similar functions are denoted by like reference numerals throughout the descriptions. The embodiments described herein with reference to drawings are explanatory, illustrative, and used to generally understand the present disclosure. The embodiments shall not be construed to limit the present disclosure.

In the specification, terms such as “first” and “second” are used herein for purposes of description and are not intended to indicate or imply relative importance or significance or to imply the number of indicated technical features. Thus, the feature defined with “first” and “second” may include one or more of this feature. In the description of the present disclosure, “A plurality of” means at least two, e.g. two, three and so on, unless specified otherwise.

In the description of the present disclosure, it should be understood that, unless specified or limited otherwise, the terms “mounted,” “supported,” “connected,” and “coupled” and variations thereof are used broadly and encompass such as mechanical or electrical mountings, connections and couplings, also can be inner mountings, connections and couplings of two components, and further can be direct and indirect mountings, connections, and couplings, which can be understood by those skilled in the art according to the detail embodiment of the present disclosure.

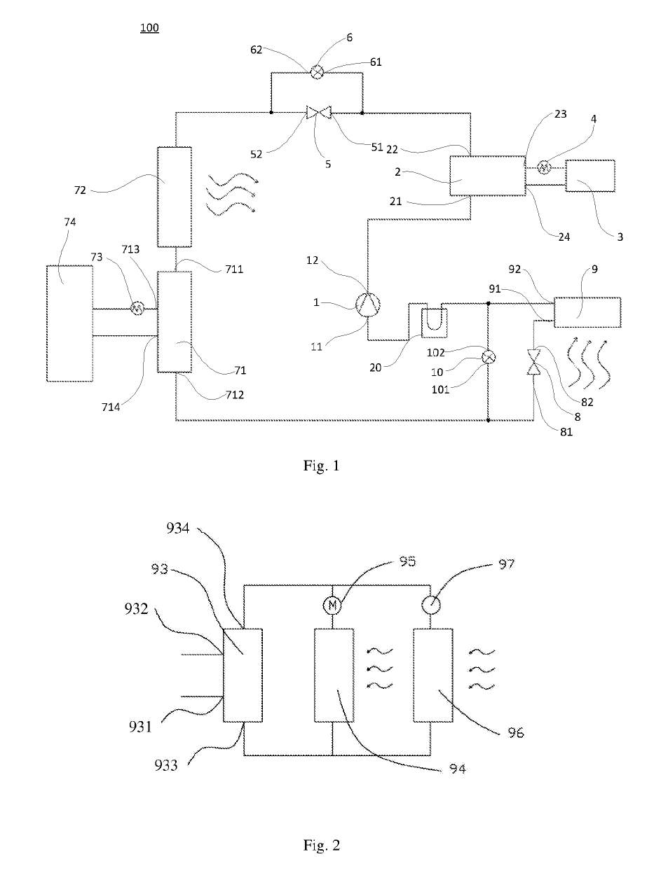

An air conditioning system 100 for a vehicle according to embodiments of the present disclosure will be described with reference to FIG. 1. It should be noted that, the air conditioning system 100 for the vehicle according to embodiments of the present disclosure is very suitable for vehicles which have no recycle for waste heat of an engine, such as an electric vehicle or a hybrid vehicle. The air conditioning system 100 for the vehicle applied in the electric vehicle or the hybrid vehicle will be described in detail as an example in the following. It should be understood that the skilled in the related art may make some minor changes to the air conditioning system to apply it in fuel vehicles after reading the description of the present disclosure.

As shown in FIG. 1, the air conditioning system 100 for the vehicle includes: a compressor 1, a first plate heat exchanger 2, a heat radiator 3, a first driving device 4, an external air heat exchanger 72, a second plate heat exchanger 71, a motor radiator 74, a second driving device 73, a first throttle control assembly and an internal refrigeration assembly.

The external air heat exchanger 72 is disposed downstream of the first plate heat exchanger 2. The first throttle control assembly is disposed between a first outlet 22 of the first plate heat exchanger 2 and an inlet 721 of the external air heat exchanger 72. The first throttle control assembly is configured to switch on/off a throttling function for a refrigerant flowing from the first plate heat exchanger 2 to the external air heat exchanger 72. That is, the first throttle control assembly can switch on the throttling function for the refrigerant flowing from the first plate heat exchanger 2 to the external air heat exchanger 72, i.e. the refrigerant flowing from the first plate heat exchanger 2 to the external air heat exchanger 72 can be throttled via the first throttle control assembly; and the first throttle control assembly can also switch off the throttling function for the refrigerant flowing from the first plate heat exchanger 2 to the external air heat exchanger 72, i.e. the refrigerant flowing from the first plate heat exchanger 2 to the external air heat exchanger 72 can directly flow through the first throttle control assembly without being throttled.

In an embodiment, the first throttle control assembly includes a first throttle device 5 and a first on-off valve 6 connected in parallel to the first throttle device 5. When the refrigerant flowing from the first plate heat exchanger 2 to the external air heat exchanger 72 flows through the first throttle device 5, it may be throttled by the first throttle device 5. When the refrigerant flowing from the first plate heat exchanger 2 to the external air heat exchanger 72 flows through the first on-off valve 6, it won't be throttled.

It should be noted that, the internal refrigeration assembly is configured to selectively cool air inside the vehicle, and disposed between a compressor inlet 11 and a third outlet 712 of the second plate heat exchanger 71. That is, the internal refrigeration assembly may selectively cool the air inside the vehicle or stop cooling. In an embodiment of the present disclosure, the internal refrigeration assembly includes a second throttle device 8, an internal heat exchanger 9 and a third on-off valve 10. A second throttle inlet 81 of the second throttle device 8 is connected to the third outlet 712 of the second plate heat exchanger 71, and a second throttle outlet 82 of the second throttle device 8 is connected to an inlet 91 of the internal heat exchanger 9. An outlet 92 of the internal heat exchanger 9 is connected to the compressor inlet 11 of the compressor 11. The internal heat exchanger 9 is configured to exchange heat with the air inside the vehicle.

The second on-off valve 10 has a first end connected to the second throttle inlet 81 of the second throttle device 8 and a second end connected to the outlet 92 of the internal heat exchanger 9. In other words, the second throttle device 8 is connected in series with the internal heat exchanger 9, then the second on-off valve 10 is connected in parallel to a whole structure including the second throttle device 8 and the internal heat exchanger 9 connected to each other in series, and thus the refrigerant may selectively flow through a pipeline where the second on-off valve 10 is located, or flow through another pipeline where the second throttle device 8 and the internal heat exchanger 9 are located. When the refrigerant flows through the pipeline where the second on-off valve 10 is located, the internal refrigeration assembly may not cool the air inside the vehicle. When the refrigerant flows through the pipeline where the second throttle device 8 and the internal heat exchanger 9 are located, the internal refrigeration assembly may cool the air inside the vehicle.

In some embodiments, the compressor 1, the first plate heat exchanger 2, the first throttle device 5, the external air heat exchanger 72, the second plate heat exchanger 71, the second throttle device 8 and the internal heat exchanger 9 are connected sequentially end to end to form a circulation loop for the refrigerant. The heat radiator 3 is connected between another pair of inlet and outlet of the first plate heat exchanger 2, to form a circulation loop for a first secondary refrigerant, for exchanging heat with the air inside the vehicle. The first on-off valve 6 is connected in parallel to the first throttle device 5, and thus the refrigerant may selectively flow through a pipeline where the first on-off valve 6 is located or another pipeline where the first throttle device 5 is located. The motor radiator 74 is connected to another pair of inlet and outlet of the second plate heat exchanger 71, to form a circulation loop for a second secondary refrigerant, and thus the refrigerant inside the second plate heat exchanger 71 may be heated by the motor radiator 74. Connection relationships among components will be described in detail as follows.

As shown in FIG. 1, the compressor 1 includes the compressor inlet 11 and a compressor outlet 12. A gaseous refrigerant enters the compressor 2 via the compressor inlet 11, then is compressed by the compressor 1, and finally runs out from the compressor outlet 12.

The first plate heat exchanger 2 is configured to achieve liquid-liquid or gas-liquid heat exchange. The first plate heat exchanger 2 includes a pair of first inlet 21 and first outlet 22 communicated with each other, and a pair of second inlet 23 and second outlet 24 communicated with each other. A first channel is formed between the first inlet 21 and the first outlet 22, a second channel is formed between the second inlet 23 and the second outlet 24, and the first channel is spaced and isolated from the second channel. The first channel is used for flowing of the refrigerant, and the second channel is used for flowing of the first secondary refrigerant, thus achieving heat exchange between the refrigerant and the first secondary refrigerant. The compressor outlet 12 of the compressor 1 is connected the first inlet 21 of the first plate heat exchanger 2, and the gaseous refrigerant after being compressed by the compressor 1 enters the first plate heat exchanger 2 via the first inlet 21.

The heat radiator 3 is connected between the second inlet 23 and the second outlet 24 of the first plate heat exchanger 2, disposed inside the vehicle and configured to exchange heat with the air inside of the vehicle. In other words, the first secondary refrigerant may first exchange heat with the refrigerant in the first plate heat exchanger 2, then flow into the heat radiator 3 to exchange heat with the air inside the vehicle via the heat radiator 3, finally flow back to the first plate heat exchanger 2 to exchange heat with the refrigerant therein again after completing the heat exchange with the air inside the vehicle, and such above circulation repeats.

The first driving device 4 is provided between the heat radiator 3 and the first plate heat exchanger 2 and configured to drive the first secondary refrigerant. In other words, the first driving device 4 is used for supplying power for the first secondary refrigerant to flow between the first plate heat exchanger 2 and the heat radiator 3. When the first driving device 4 operates, the first secondary refrigerant may be driven to flow between the first plate heat exchanger 2 and the heat radiator 3. When the first driving device 4 is turned off, the first secondary refrigerant may stop flowing between the first plate heat exchanger 2 and the heat radiator 3. In some embodiments, the first driving device 4 may be a first water pump. When the first water pump is supplied with electricity, the first secondary refrigerant may be driven to flow between the first plate heat exchanger 2 and the heat radiator 3, and thus the first driving device 4 has a simple structure and is easy to be implemented.

The first throttle device 5 has two states, namely an on state and an off state, and may be freely switchable between the two states. The first outlet 22 of the first plate heat exchanger 2 is connected to the first throttle inlet 51 of the first throttle device 5. When the first throttle device 5 is switched on, the refrigerant may flow through the first throttle device 5 and be throttled thereby. When the first throttle device 5 is switched off, the refrigerant cannot flow through the first throttle device 5 and cannot be throttled by the first throttle device 5, either.

The first on-off valve 6 is used to selectively unblock or cut off a pipeline where the first on-off valve 6 is located. When the first on-off valve 6 is switched on, the pipeline where the first on-off valve 6 is located is unblocked, and the refrigerant may flow through the pipeline where the first on-off valve 6 is located. When the first on-off valve 6 is switched off, the pipeline where the first on-off valve 6 is located is cut off, and the refrigerant cannot flow through the pipeline where the first on-off valve 6 is located. The first on-off valve 6 is connected in parallel to the first throttle device 5. In other words, an inlet 61 of the first on-off valve 6 is connected to the first throttle inlet 51 of the first throttle device 5, and an outlet 62 of the first on-off valve 6 is connected to the first throttle outlet 52 of the first throttle device 5.

The external air heat exchanger 72 is disposed outside of the vehicle, and configured to exchange heat with air outside the vehicle. The inlet of the external air heat exchanger 72 is connected to the first throttle outlet 52 of the first throttle device 5, i.e. the inlet of the external air heat exchanger 72 is also connected to the outlet 62 of the first on-off valve 6, and thus the refrigerant flowing through the first on-off valve 6 or the first throttle device 5 may enter the external air heat exchanger 72 via the inlet of the external air heat exchanger 72, so as to exchange heat with the air outside of the vehicle. In one embodiment, the external air heat exchanger 72 is a finned heat exchanger, and thus the external air heat exchanger 72 may have a simple structure and a low cost. In another embodiment, the external air heat exchanger 72 is a microchannel heat exchanger, and thus the external air heat exchanger 72 has reduced space occupation and improved heat exchanging efficiency.

The second plate heat exchanger 71 is configured to achieve liquid-liquid or gas-liquid heat exchange. The second plate heat exchanger 71 includes a pair of third inlet 711 and third outlet 712 communicated with each other, and a pair of fourth inlet 713 and fourth outlet 714 communicated with each other. A third channel is formed between the third inlet 711 and the third outlet 712, a fourth channel is formed between the fourth inlet 713 and fourth outlet 714, and the third channel is spaced and isolated from the fourth channel. The third channel is used for flowing of the refrigerant, and the fourth channel is used for flowing of the second secondary refrigerant, thus achieving heat exchange between the refrigerant and the second secondary refrigerant. In some embodiments, an outlet of the external air heat exchanger 72 is connected to the third inlet 711 of the second plate heat exchanger 71.

The motor radiator 74 is used as a heat radiating device for a motor of the electric vehicle or the hybrid vehicle. The second secondary refrigerant inside the motor radiator 74 may absorb heat from the motor and then exchange heat with the refrigerant inside the second plate heat exchanger 71. In some embodiments, the motor radiator 74 is connected between the fourth inlet 713 and the fourth outlet 714 of the second plate heat exchanger 71.

In some embodiments, a second driving device 73 is provided between the motor radiator 74 and the second plate heat exchanger 71 and configured to drive the second secondary refrigerant, i.e. the second driving device 73 is used to supply power for the second secondary refrigerant to flow between the second plate heat exchanger 71 and the motor radiator 74. When the second driving device 73 operates, the second secondary refrigerant may be driven to flow between the second plate heat exchanger 71 and the motor radiator 74. When the second driving device is turned off, the second secondary refrigerant may stop flowing between the second plate heat exchanger 71 and the motor radiator 74. In some embodiments, the second driving device 73 is a second water pump. When the second water pump is supplied with electricity, the second secondary refrigerant may be driven to flow between the second plate heat exchanger 71 and the motor radiator 74, and thus the second driving device 73 has a simple structure and is easy to be implemented.

The second throttle inlet 81 of the second throttle device 8 is connected to the third outlet 712 of the second plate heat exchanger 71. The second throttle device 8 has two states, namely an on state and an off state, and may be freely switchable between the two states. When the second throttle device 8 is switched on, the refrigerant may flow through the second throttle device 8 and be throttled thereby. When the second throttle device 8 is switched off, the refrigerant cannot flow through the second throttle device 8 and cannot be throttled by the second throttle device 8, either.

The second on-off valve 10 is configured to selectively unblock or cut off a pipeline where the second on-off valve 10 is located. When the second on-off valve 10 is switched on, the pipeline where the second on-off valve 10 is located is unblocked, and the refrigerant may flow through the pipeline where the second on-off valve 10 is located. When the second on-off valve 10 is switched off, the pipeline where the second on-off valve 10 is located is cut off, and the refrigerant cannot flow through the pipeline where the second on-off valve 10 is located. The second on-off valve 10 has the first end connected to the second throttle inlet 81 of the second throttle device 8 and the second end connected to the outlet 92 of the internal heat exchanger 9. In other words, an inlet 101 of the second on-off valve 10 is connected to a point between the third outlet 712 of the second plate heat exchanger 71 and the second throttle inlet 81 of the second throttle device 8, and an outlet 102 of the second on-off valve 10 is connected to a point between the outlet 92 of the internal heat exchanger 9 and the compressor inlet 11 of the compressor 1.

The air conditioning system 100 for the vehicle according to the present disclosure, distinguished from the heat pump air conditioning system with a four-way reversing valve in the prior art, may avoid some problems, such as the internal leakage and cross flow of the refrigerant caused by the failure of the four-way reversing valve, further enable a more stable operation thereof, and solve some problems existing in the current air conditioning system, such as a cooling or heating delay, a poor comfort and so on. Moreover, the air conditioning system 100 for the vehicle according to embodiments of the present disclosure, distinguished from the air conditioning system using the PTC to heat in the prior art, shows a low power consumption, which can increase the endurance mileage of the electric vehicle and the hybrid vehicle, and thus is very suitable for the electric vehicle and hybrid vehicle.

In some embodiments, the air conditioning system 100 for the vehicle further includes a gas-liquid separator 20. The gas-liquid separator 20 is disposed between the internal refrigeration assembly and the compressor 1. In detail, the gas-liquid separator 20 is disposed between the internal heat exchanger 9 and the compressor 1. In some embodiments, an inlet of the gas-liquid separator 20 is connected to the outlet 102 of the second on-off valve 10 and the outlet 92 of the internal heat exchanger 9 respectively, and an outlet of the gas-liquid separator 20 is connected to the compressor inlet 11 of the compressor 1. With the gas-liquid separator 20, the compressor 1 may be protected, which may prevent the liquid refrigerant from entering the compressor 1 and destroying the compressor 1 by an impact of the liquid refrigerant.

In one embodiments of the present disclosure, the internal heat exchanger 9 is a finned heat exchanger or a microchannel heat exchanger, so that the internal heat exchanger 9 may directly exchange heat with the air inside the vehicle, and thus the internal heat exchanger 9 has a simple structure and is easy to be implemented.

In another embodiment of the present disclosure, the internal heat exchanger 9 includes a third plate heat exchanger 93 and an air heat exchanger 94.

In some embodiments, the third plate heat exchanger 93 is configured to achieve liquid-liquid or gas-liquid heat exchange. The third plate heat exchanger 93 includes a pair of fifth inlet 931 and fifth outlet 932 communicated with each other, and a pair of sixth inlet 933 and sixth outlet 934 communicated with each other. A fifth channel is formed between the fifth inlet 931 and the fifth outlet 932, a sixth channel is formed between the sixth inlet 933 and the sixth outlet 934, and the fifth channel is spaced and isolated from the sixth channel. The fifth channel is used for flowing of the refrigerant, and the sixth channel is used for flowing of a third secondary refrigerant, thus achieving heat exchange between the refrigerant and the third secondary refrigerant. The fifth inlet 931 is connected to the second throttle outlet 82 of the second throttle device 8, and the fifth outlet 932 is connected to the compressor inlet 11 of the compressor 1.

The air heat exchanger 94 is connected between the sixth inlet 933 and the sixth outlet 934, disposed inside the vehicle and configured to exchange heat with air inside the vehicle. In other words, the third secondary refrigerant may exchange heat with the refrigerant in the third plate heat exchanger 93, then flow into the air heat exchanger 94 to exchange heat with the air inside the vehicle via the air heat exchanger 94, finally flow back to the third plate heat exchanger 93 to exchange heat with the refrigerant therein again after completing the heat exchange with the air inside the vehicle, and such above circulation repeats. Therefore, the structure of the internal heat exchanger 9 may be diversified for free assembling.

In some embodiments, the air heat exchanger 94 is a finned heat exchanger or a microchannel heat exchanger, and thus the air heat exchanger 94 may directly exchange heat with the air inside the vehicle.

In some embodiments, a third driving device, preferably, a third water pump 95, is provided between the third plate heat exchanger 93 and the air heat exchanger 94, and configured to drive the third secondary refrigerant to flow between the third plate heat exchanger 93 and the air heat exchanger 94. In other words, the third water pump 95 is used for supplying power for the third secondary refrigerant to flow between the third plate heat exchanger 93 and the air heat exchanger 94. When the third water pump 95 operates, the third secondary refrigerant may be driven to flow between the third plate heat exchanger 93 and the air heat exchanger 94. When the third water pump 95 is switched off, the third secondary refrigerant may stop flowing between the third plate heat exchanger 93 and the air heat exchanger 94. Thus, the third driving device has a simple structure and is easy to be implemented.

In some embodiments, a heat exchanging device 96 is connected between the sixth inlet 933 and the sixth outlet 934. Specifically, a three-way valve may be provided at the sixth inlet 933 and the sixth outlet 934 respectively, and thus the heat exchanging device 96 may be in a parallel connection with the air heat exchanger 94. In some embodiments, the heat exchanging device 96 is configured to supply a cold source for a battery of the electric vehicle or the hybrid vehicle, and thus the air conditioning system 100 for the vehicle may cool the air inside the vehicle and assist in cooling the battery at the same time, which may elevate functionality of the air conditioning system 100.

In some embodiments, in order to facilitate adjustment of the refrigerant distribution between the heat exchanging device 96 and the air heat exchanger 94, a flow control device 97 is disposed in at least one of a pipeline where the heat exchanging device 96 is located and a pipeline where the air heat exchanger 94 is located. The flow control device 97 may be an on-off valve or an opening adjustment valve, which may control the refrigerant distribution between the heat exchanging device 96 and the air heat exchanger 94.

The controlling method of the air conditioning system 100 for the vehicle according to embodiments of the present disclosure will be described in detail with reference to FIG. 1 in the following.

The air conditioning system 100 for the vehicle according to embodiments of the present disclosure has four operation modes, including a cooling mode, a heating mode, a cooling-heating compatible mode and a heating-defrosting mode. The controlling method of the air conditioning system 100 for the vehicle includes following steps.

Firstly, when the cooling mode is started, the first driving device 4, the first throttle device 5, the second driving device 73 and the second on-off valve 10 are controlled to be switched off, and the first on-off valve 6 and the second throttle device 8 are controlled to be switched on. Such mode may be started at high environment temperature, so as to cool the air inside the vehicle.

The refrigerant has a following circulation path: a gaseous refrigerant with a high temperature and a high pressure flowing out from the compressor 1, sequentially flows through the first channel of the first plate heat exchanger 2 and the first on-off valve 6 and enters the external air heat exchanger 72 to exchange heat with the air outside of the vehicle, so as to be condensed into form a liquid refrigerant with a medium temperature and a high pressure; then the liquid refrigerant flowing out from the external air heat exchanger 72, flows through the third channel of the second plate heat exchanger 71 to the second throttle device 8 and is throttled by the second throttle device 8 to be turned into a liquid refrigerant with a low temperature and a low pressure; the liquid refrigerant with the low temperature and the low pressure enters the internal heat exchanger 9 to exchange heat with the air inside the vehicle, so as to cool the air inside the vehicle and lower the temperature thereof, and the refrigerant also absorbs heat to form a gaseous refrigerant with a low temperature and a low pressure; finally the gaseous refrigerant with the low temperature and the low pressure flows back to the compressor 1 through the gas-liquid separator 20, and thus a circulation of the refrigerant is completed under the cooling mode.

Secondly, when the heating mode is started, the first driving device 4, the first throttle device 5, the second driving device 73 and the second on-off valve 10 are controlled to be switched on, and the first on-off valve 6 and the second throttle device 8 are controlled to be switched off. Such heating mode may be started in a low environment temperature, so as to heat the air inside the vehicle.

The refrigerant has a following circulation path: a gaseous refrigerant with a high temperature and a high pressure flowing out from the compressor 1, flows through the first channel of the first plate heat exchanger 2 and exchanges heat with the first secondary refrigerant, so as to be cooled and condensed into a liquid refrigerant with a medium temperature and a high pressure, then the liquid refrigerant with the medium temperature and the high pressure flows through the first throttle device 5 to be throttled and depressurized into a liquid refrigerant with a low temperature and a low pressure; then the liquid refrigerant with the low temperature and the low pressure flows into the external air heat exchanger 72 to absorb heat from the air outside the vehicle so as to be vaporized, further flows into the third channel of the second plate heat exchanger 71 to absorb heat from the second secondary refrigerant so as to be further vaporized, and thus the liquid refrigerant with the low temperature and the low pressure is turned into a gaseous refrigerant with a low temperature and a low pressure; finally the gaseous refrigerant with the low temperature and the low pressure flows through the second on-off valve 10 and further back to the compressor 1 via the gas-liquid separator 20, and thus a circulation of the refrigerant is completed under the heating mode. The second plate heat exchanger 71 is provided for the refrigerant to absorb heat from the motor radiator 74, thereby improving the heating efficiency.

The secondary refrigerants have following circulation paths: under the action of the first driving device 4, the first secondary refrigerant flows through the second channel of the first plate heat exchanger 2 and absorbs heat from the gaseous refrigerant with the high temperature and the high pressure to form a secondary refrigerant with a high temperature, then the secondary refrigerant with the high temperature flows through the heat radiator 3 and exchanges heat with the air inside the vehicle to heat the air inside the vehicle, and the secondary refrigerant finally flows back to the first plate heat exchanger 2 to absorb heat after having released heat, and thus a circulation of the first secondary refrigerant inside the first plate heat exchanger 2 is completed;

under the action of the second driving device 73, the second secondary refrigerant flows through the fourth channel of the second plate heat exchanger 71 and releases heat to the liquid refrigerant with the low temperature and the low pressure to form a secondary refrigerant with a low temperature, then the secondary refrigerant with the low temperature flows through the motor radiator 74 to absorbs heat from the motor, and further flows back to the second plate heat exchanger 71 to exchange heat with the refrigerant again, and thus a circulation of the second secondary refrigerant inside the second plate heat exchanger 71 is completed. Under this operation mod, the second plate heat exchanger 71 may exchange heat by the second secondary refrigerant absorbing heat from the motor, which may prevent the second plate heat exchanger 71 from frosting under a condition of a low temperature.

Thirdly, when the cooling-heating compatible mode is started, the first driving device 4, the first on-off valve 6 and the second throttle device 8 are controlled to be switched on, and the first throttle device 5, the second driving device 73 and the second on-off valve 10 are controlled to be switched off. This operation mode may be started in spring and autumn, so as to heat and cool the air inside the vehicle at the same time, thus improving the comfort inside of the vehicle.

The refrigerant has a following circulation path: a gaseous refrigerant with a high temperature and a high pressure flowing out from the compressor 1, flows through the first channel of the first plate heat exchanger 2 to form a gaseous refrigerant with a medium temperature and a high pressure, then the gaseous refrigerant with the medium temperature and the high pressure flows through the first on-off valve 6 and enters the external air heat exchanger 72 to release heat to the air outside of the vehicle, so as to be condensed into a liquid refrigerant with a medium temperature and a high pressure; then the liquid refrigerant flowing out from the external air heat exchanger 72, flows through the third channel of the second plate heat exchanger 71 to the second throttle device 8 and is throttled by the second throttle device 8 into a liquid refrigerant with a low temperature and a low pressure; the liquid refrigerant with the low temperature and the low pressure enters the internal heat exchanger 9 to exchange heat with the air inside the vehicle, so as to cool the air inside the vehicle and lower the temperature thereof, and the liquid refrigerant also absorbs heat to form a gaseous refrigerant with a low temperature and a low pressure; finally the gaseous refrigerant with the low temperature and the low pressure flows back to the compressor 1 via the gas-liquid separator 20, and thus a circulation of the refrigerant is completed for a purpose of refrigeration under the cooling-heating compatible mode.

The secondary refrigerant has a following circulation path: under the action of the first driving device 4, the first secondary refrigerant flows through the second channel of the first plate heat exchanger 2 and exchanges heat with the gaseous refrigerant with the high temperature and the high pressure to form a secondary refrigerant with a high temperature, then the secondary refrigerant with the high temperature flows through the heat radiator 3 and exchanges heat with the air inside the vehicle to heat the air inside the vehicle, and the secondary refrigerant further flows back to the first plate heat exchanger 2 to exchange heat so as to increase its own temperature after having released heat, and thus a circulation of the first secondary refrigerant inside the first plate heat exchanger 2 is completed.

Fourthly, when the defrosting mode is started, the first driving device 4, the first on-off valve 6 and the second on-off valve 10 are controlled to be switched on, and the first throttle device 5, the second driving device 73 and the second throttle device 8 are controlled to be switched off. This operation mode may be started in winter having a decreased temperature, and the external air heat exchanger 72 needs to be defrosted. Under this operation mode, the air inside the vehicle can be heated at the same time, during the defrostation of the external air heat exchanger 72.

The refrigerant has a following circulation path: a gaseous refrigerant with a high temperature and a high pressure flowing out from the compressor 1, flows through the first channel of the first plate heat exchanger 2 to exchange a small amount of heat with the first secondary refrigerant to form a gaseous refrigerant with a medium temperature and a high pressure, then the gaseous refrigerant with the medium temperature and the high pressure flows through the first on-off valve 6 and enters the external air heat exchanger 72 and the third channel of the second plate heat exchanger 71 which have already frosted up to defrost the external air heat exchanger 72 and the third channel of the second plate heat exchanger 71 by a hot gas (the gaseous refrigerant), and the refrigerant may be cooled to form a gaseous refrigerant with a medium temperature and a medium pressure; the gaseous refrigerant with the medium temperature and the medium pressure flows through the second on-off valve 10 and the gas-liquid separator 20 sequentially and further back to the compressor 1 for compression, and thus a circulation of the refrigerant is completed, so that a defrosting effect of the external air heat exchanger 72 and the second plate heat exchanger 71 in a low-temperature environment is achieved.

The secondary refrigerant has a following circulation path: under the action of the first driving device 4 having a not too large flow, the first secondary refrigerant flows through the second channel of the first plate heat exchanger 2 and absorbs heat from the gaseous refrigerant with the high temperature and the high pressure to form a secondary refrigerant with a high temperature, then the secondary refrigerant with the high temperature flows through the heat radiator 3 and exchanges heat with the air inside the vehicle to heat the air inside the vehicle, and the secondary refrigerant further flows back to the first plate heat exchanger 2 to exchange heat so as to increase its own temperature after having released heat, and thus a circulation of the first secondary refrigerant for simultaneous heating during the defrostation is completed.

In summary, with the controlling method according to the second aspect of embodiments of the present disclosure, without changing the circulation direction of the refrigerant, as shown in FIG. 1, the refrigerant flowing inside the air conditioning system 100 of the vehicle may have a substantially anti-clockwise circulation path. And also, the air conditioning system 100 of the vehicle may achieve a cooling function, a heating function, a simultaneous cooling-heating function, and a heating-defrosting function. Furthermore, the air conditioning system has a simple structure, a high comfort and low energy consumption.

According to the third aspect of embodiments of the present disclosure, a vehicle including the air conditioning system according to the present disclosure is provided. With the air conditioning system according to the present disclosure having above advantages, the vehicle including the air conditioning system may be more energy efficient, and show better performances and driving comfort.

Reference throughout this specification to “one embodiment”, “some embodiments,” “an embodiment”, “a specific example,” or “some examples,” means that a particular feature, structure, material, or characteristic described in connection with the embodiment or example is included in at least one embodiment or example of the present disclosure. Thus, the appearances of the phrases in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated that the above embodiments are explanatory and cannot be construed to limit the present disclosure, and changes, alternatives, and modifications can be made in the embodiments without departing from scope of the present disclosure by those skilled in the art.

What is claimed is:

1. An air conditioning system for a vehicle, comprising:
a compressor, comprising a compressor inlet and a compressor outlet;
a first plate heat exchanger, comprising a pair of first inlet and first outlet communicated with each other, and a pair of second inlet and second outlet communicated with each other, wherein the compressor outlet is connected to the first inlet;
a heat radiator, connected between the second inlet and the second outlet of the first plate heat exchanger, disposed inside the vehicle and configured to exchange heat with air inside of the vehicle, wherein a first driving device is provided between the heat radiator and the first plate heat exchanger and is configured to drive a first secondary refrigerant;
an external air heat exchanger, disposed downstream of the first plate heat exchanger;
a second plate heat exchanger, comprising a pair of third inlet and third outlet communicated with each other, and a pair of fourth inlet and fourth outlet communicated with each other, wherein the third inlet is connected to an outlet of the external air heat exchanger;
a motor radiator, configured to radiate heat of a motor of the vehicle, connected between the fourth inlet and the fourth outlet of the second plate heat exchanger, wherein a second driving device is provided between the motor radiator and the second plate heat exchanger and is configured to drive a second secondary refrigerant;
a first throttle control assembly, disposed between the first outlet of the first plate heat exchanger and an inlet of the external air heat exchanger, configured to switch on/off a throttling function for a refrigerant flowing from the first plate heat exchanger to the external air heat exchanger; and
an internal refrigeration assembly, configured to selectively cool the air inside the vehicle, and disposed between the compressor inlet and the third outlet of the second plate heat exchanger.

2. The air conditioning system according to claim 1, wherein the first throttle control assembly comprises:
a first throttle device, configured to be selectively switched on or off, having a first throttle inlet connected to the first outlet of the first plate heat exchanger, and a first throttle outlet connected to the inlet of the external air heat exchanger; and
a first on-off valve, configured to selectively unblock or cut off a pipeline where the first on-off valve is disposed, and connected in parallel to the first throttle device.

3. The air conditioning system according to claim 1, wherein the internal refrigeration assembly comprises:
a second throttle device, having a second throttle inlet and a second throttle outlet, wherein the second throttle inlet is connected to the third outlet of the second plate heat exchanger;
an internal heat exchanger, configured to exchange heat with the air inside the vehicle, having an inlet connected to the second throttle outlet and an outlet connected to the compressor inlet; and
a second on-off valve, configured to selectively unblock or cut off a pipeline where the second on-off valve is disposed, having a first end connected to the second throttle inlet of the second throttle device and a second end connected to the outlet of the internal heat exchanger.

4. The air conditioning system according to claim 3, wherein the internal heat exchanger is a finned heat exchanger or a microchannel heat exchanger.

5. The air conditioning system according to claim 3, wherein the internal heat exchanger comprises:
a third plate heat exchanger, comprising a pair of fifth inlet and fifth outlet communicated with each other, and a pair of sixth inlet and sixth outlet communicated with each other, wherein the fifth inlet is connected to the second throttle outlet, the fifth outlet is connected to the compressor inlet; and
an air heat exchanger, connected between the sixth inlet and the sixth outlet, disposed inside the vehicle and configured to exchange heat with the air inside the vehicle.

6. The air conditioning system according to claim 5, wherein the internal heat exchanger further comprises:
a third driving device, disposed between the air heat exchanger and the third plate heat exchanger, and configured to drive a third secondary refrigerant.

7. The air conditioning system according to claim 6, wherein the internal heat exchanger further comprises:
a heat exchanging device, connected between the sixth inlet and the sixth outlet by means of being in a parallel connection with the air heat exchanger, and configured to supply a cold source for a battery of the vehicle; and
a flow control device, disposed in at least one of a pipeline where the heat exchanging device is located and a pipeline where the air heat exchanger is located.

8. The air conditioning system according to claim 6, wherein the first driving device is a first water pump.

9. The air conditioning system according to claim 5, wherein the air heat exchanger is a finned heat exchanger or a microchannel heat exchanger.

10. The air conditioning system according to claim 1, wherein the external air heat exchanger is a finned heat exchanger or a microchannel heat exchanger.

11. The air conditioning system according to claim 1, further comprising:
a gas-liquid separator, disposed between the internal refrigeration assembly and the compressor.

12. A vehicle comprising an air conditioning system according to claim 1.

13. The air conditioning system according to claim 6, wherein the second driving device is a second water pump.

14. The air conditioning system according to claim 6, wherein the third driving device is a third water pump.
